(19) United States
(12) Patent Application Publication
(10) Pub. No.: US 2011/0234557 A1
(43) Pub. Date: Sep. 29, 2011

(54) ELECTROPHORETIC DISPLAY DEVICE AND METHOD FOR DRIVING SAME

(76) Inventors: Chang-Jing Yang, Taoyuan Hsien (TW); Yu-Kai Chen, Taoyuan Hsien (TW); Jau-Shiu Chen, Taoyuan Hsien (TW); Rong-Chang Liang, Cupertino, CA (US)

(21) Appl. No.: 12/732,903

(22) Filed: Mar. 26, 2010

(51) Int. Cl. G06F 3/038

(52) U.S. Cl. 345/207

(57) ABSTRACT

An electrophoretic display device is provided. The display device includes a first substrate, a second substrate opposite to the first substrate, a plurality of particles disposed between the two substrates, a driving circuit and a sensor. The driving circuit is configured for a display mode by imagewise driving the particles to display one or more images and configured for an idle mode by causing the particles to move away from at least one of the two substrates and to be non-imagewise dispersed in between the two substrates so as to form a substantially non-imagewise bistable state between the two substrates in the idle mode. The sensor senses or detects the usage status of the display device or the environmental parameters associated with a surrounding environment. The driving circuit is configured for either the display mode or the idle mode in accordance with the usage status or the environmental parameters.

### BACKGROUND OF THE INVENTION

1. Field of the Invention

The present invention relates to a display device, and more particularly, to an electrophoretic display device and a method for driving the same.

2. Description of the Related Art

There are two major types of electrophoretic display technologies; namely, the powder type in which particles of different polarities and contrast colors suspend in a gaseous medium, as shown in FIG. 8A; and the liquid type in which charged particles are dispersed in a dielectric fluid, as shown in FIGS. 8B and 8C. FIG. 8B shows a typical microcapsule type electrophoretic display device comprising particles of different polarities and contrast colors dispersed in a dielectric fluid. FIG. 8C shows a typical microcup type electrophoretic display device comprising charged particles dispersed in a dielectric fluid of contrast color.

There is a plurality of display elements in an electrophoretic display device. As shown in FIG. 1A, an electrophoretic display device 100 comprises a first substrate 110 and the corresponding second substrate 120. There are planes of opposing electrodes 130 and 140 on the substrates 110 and 120, respectively. Charged particles 150 and 160 of different polarities and contrast colors are separately gathered in space 170 between the electrodes 130 and 140. When the applied voltage between the electrodes 130 and 140 is stronger than the threshold voltage, these particles 150 and 160 will move toward the electrode 130 or 140 with opposite polarity. A picture can be seen from the light generated from a light source 180, emitted through the transparent substrate 110 twice, and reflected from the surfaces of the particles 150. For example, when negatively charged white particles 150 move toward the first electrode 130 under the Coulomb forces, the reflected color from the transparent first substrate 110 will be white. In contrast, when positively charged black particles 160 move toward the first electrode 130, then the color is black. This kind of electrophoretic display device is referred to as a top-down switching mode device. Similar display device principles can be applied to in-plane switching mode display devices and dual mode display devices. As shown in FIG. 1C, for in-plane switching mode display devices, the opposite-charged electrodes 130 and 140 are positioned on the same substrate. As shown in FIG. 1E, for dual mode display devices, the opposite-charged electrodes 130 and 140 are positioned on both the opposing and the same substrate.

In a display apparatus operated in the in-plane switching mode, both electrodes are on the same plane or substrate. In a display apparatus operated in the top-down switching mode, the two electrodes are on different (top and bottom) substrates. In all cases, at least one of the two substrates is transparent so that the state of the particles can be viewed through the transparent substrate. When a voltage difference or an electrical field is imposed between the first and second electrodes, the pigment particles migrate to the electrode which has opposite polarity to the pigment particles. Thus, changes in the color or shade displayed through the transparent electrode are facilitated by selectively changing the polarities of the electrodes.

Not to be bound by theory, it is believed that when the pigment particles 150 and 160 migrate to and contact the electrodes 130 and 140 with the polarity opposite to the pigment particles 150 and 160, respectively, electrons may gradually leak through the contact surface therebetween even after the power is turned off. Thus, the longer the particles 150 and 160 contact the electrodes, the less charge density (charge per unit weight, Q/W) remains on the particle surface and the more difficult it is to re-drive the pigment particles by an electric field. Furthermore, the pigment particles 150 and 160 more easily aggregate or flocculate since the repulsion force between the two particles of the same charge polarity also decreases as the charges leak through the electrodes. As a result, a higher driving voltage is required to achieve the same contrast ratio or response time as originally, after the particles 150 and 160 stay or age at the bi-stable mode for a period of time. In an extreme case, as shown in FIG. 2A, image sticking results, sometimes also called image retention or ghosting, which is a phenomenon where a faint outline of a previously displayed image remains visible on a screen when the image is changed. Accordingly, to prevent pigment-particle charges from decreasing and image sticking, conventionally, a screen may be periodically refreshed to reduce the degree of particle aggregation and the charge leakage through the electrodes. For powder type electrophoretic displays, such periodical refresh operations or perturbation may also help recharge the pigment particles 150 and 160 through triboelectric interaction among particles. However, the degree of image sticking is reduced at the expense of the length of the bistable state. This results in a decrease in operating life span and an increase in power consumption of the particle-based displays. Alternatively, an insulating layer may be employed to protect the electrodes and reduce the charge leakage (for examples, U.S. Pat. No. 3,668,106; Ota, 1972). However, after the power is turned off, a reverse bias voltage may result which tends to pull the particles back to an opposing side of the electrode and reduce bistability, thus making passive matrix driving difficult due to the presence of a strong reverse bias.

It has been disclosed that the reverse bias may be reduced and bistability may be improved by using an insulating passivation layer with a controlled dielectric constant by, for example, employing relatively polar materials such as polyurethane, polyurea, Nylon . . . etc. optionally with trace amount of polar additives. See, for example, U.S. Pat. Nos. 7,572,491, 7,564,614 (2009), 7,166,182 (2007). In U.S. Pat. No. 6,870,662 (2005), a longer shelf life, higher image bistability and higher threshold voltage were disclosed by surface modification of an electrode protecting layer and a partition wall of a micro-cup type electrophoretic display (EPD) by using plasma treatment in the presence of a polar probe. However, such polar materials with high dielectric constants often result in a trade-off in environmental stability, particularly in highly humid environments.

It is known in the art that an electrophoretic display can be provided with a sensor. For example, U.S. Pat. No. 6,751,007 discloses that a photocell sensor may be used to modulate backlight intensity to reduce power consumption of an electrophoretic display device. U.S. Pat. No. 7,126,743 discloses an electrophoretic display device provided with a temperature sensor. However, the prior art sensors or detectors are not used to achieve a substantially non-imagewise bistable state of the charged particles.

Therefore, a new method is desired to mitigate the above mentioned deficiencies for particle-based displays.

### BRIEF SUMMARY OF THE INVENTION

An electrophoretic display device and methods for driving the same are provided. An embodiment of an electrophoretic display device having an essential non-imagewise bistable state comprises a first substrate, a second substrate, a plurality of charged particles disposed between the first and second substrates, a driving circuit, and a sensor. The second substrate is opposite to the first substrate. The plurality of charged particles are disposed between the first and second substrates. The driving circuit is configured for a display mode by imagewise driving the plurality of charged particles to display one or more images and configured for an idle mode by causing the plurality of charged particles to move away from at least one of the two substrates and to be non-imagewise dispersed in between the two substrates so as to form a substantially non-imagewise bistable state between the two substrates in the idle mode. The sensor senses or detects a usage status of the electrophoretic display device or one or more environmental parameters associated with a surrounding environment of the electrophoretic display device, wherein the driving circuit is configured for either the display mode or the idle mode in accordance with the usage status or the one or more environmental parameters sensed or detected.

Furthermore, an embodiment of a method for driving an electrophoretic display device is provided, wherein the electrophoretic display device comprises a first substrate, a second substrate opposite to the first substrate, a first electrode disposed on the first substrate, a second electrode disposed on the second substrate, a plurality of charged particles disposed in between the first and second substrates, and a sensor. The method comprises sensing or detecting a usage status of the electrophoretic display device or one or more environmental parameters associated with a surrounding environment of the electrophoretic display device; and in accordance with the usage status or the one or more environmental parameters sensed or detected, generating either an electric field to cause the plurality of charged particles to move imagewise toward and to contact with at least one of the first and second electrodes or another electric field to cause the plurality of charged particles to move non-imagewise and substantially away from the first and second electrodes so as to form a substantially non-imagewise bistable state.

Moreover, another embodiment of a method for driving an electrophoretic display device is provided, wherein the electrophoretic display device comprises a first substrate, a second substrate opposite to the first substrate, a first electrode disposed on the second substrate, a second electrode disposed on the second substrate, a plurality of charged particles disposed in between the first and second substrates, and a sensor. The method comprises sensing or detecting a usage status of the electrophoretic display device or one or more environmental parameters associated with a surrounding environment of the electrophoretic display device; and in accordance with the usage status or the one or more environmental parameters sensed or detected, generating either an electric field to cause the plurality of charged particles to move imagewise toward and to contact with at least one of the first and second electrodes or another electric field to cause the plurality of charged particles to move non-imagewise and substantially away from the first and second electrodes so as to form a substantially non-imagewise bistable state.

A detailed description is given in the following embodiments with reference to the accompanying drawings.

### BRIEF DESCRIPTION OF DRAWINGS

The invention can be more fully understood by viewing the subsequent detailed description and examples with references made to the accompanying drawings, wherein:

FIG. 1A shows a side view of a top-down switching mode of a conventional electrophoretic display device;

FIG. 1B shows a side view of a top-down switching mode of the electrophoretic display device at a non-imagewise bistable state of idling according to the present invention;

FIG. 1C shows a side view of an in-plane switching mode of a conventional electrophoretic display device;

FIG. 1D shows a side view of an in-plane switching mode of the electrophoretic display device at a non-imagewise bistable state of idling according to the present invention;

FIG. 1E shows a side view of a dual switching mode of a conventional electrophoretic display device;

FIG. 1F shows a side view of a dual switching mode of the electrophoretic display device at a non-imagewise bistable state of idling according to the present invention;

FIG. 2A shows a top view of imaging particles contacting an electrode according to prior art;

FIG. 2B shows a top view of imaging particles at a non-imagewise bistable state of idling according to the present invention;

FIG. 3 shows the structure of the electrophoretic display device according to an embodiment of the present invention;

FIG. 4 shows the flow chart for the driving method of the electrophoretic display device according to the present invention;

FIG. 5 shows a schematic diagram for the waveform used in the controller according to one embodiment of the present invention;

FIG. 6 shows the distribution of normalized grey scale of an electrophoretic display device under a normal black image and under a non-imagewise bistable state of idling, respectively;

FIG. 7A shows three areas of QR-LPD which present black, non-imagewise bistable state of idling and white image in acceleration aging test;

FIG. 7B shows a comparison of contrast ratio of QR-LPD under black, white image and non-imagewise bistable state of idling;

FIG. 8A shows a typical powder type electrophoretic display device comprising particles of different polarities and contrast colors suspended in a gaseous medium in the display cells;

FIG. 8B shows a typical microcapsule type electrophoretic display device comprising particles of different polarities and contrast colors dispersed in a dielectric fluid; and

FIG. 8C shows a typical microcup type electrophoretic display device comprising charged particles dispersed in a dielectric fluid of contrast color.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

According to the present invention, when the electrophoretic display device is under a non-imagewise bistable state of idling, a plurality of charged particles are spread out and widely distributed in the mid-zone between the first and second substrates, providing no recognizable image, and minimizing a possibility for contacting electrodes with opposite polarities.

According to the present invention, when the electrophoretic display device is under a non-imagewise bistable state of idling, the charged particles are dispersed loosely in the space between the first and the second substrates. Because there is minimal amount of contact among the charged particles and thus lower packing density, particles do not clog together or form clusters.

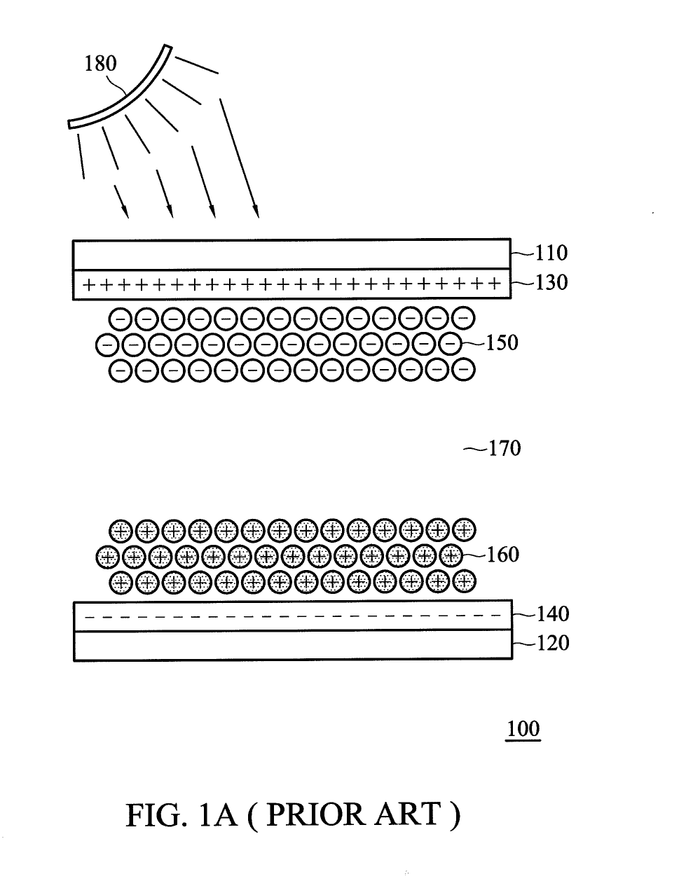

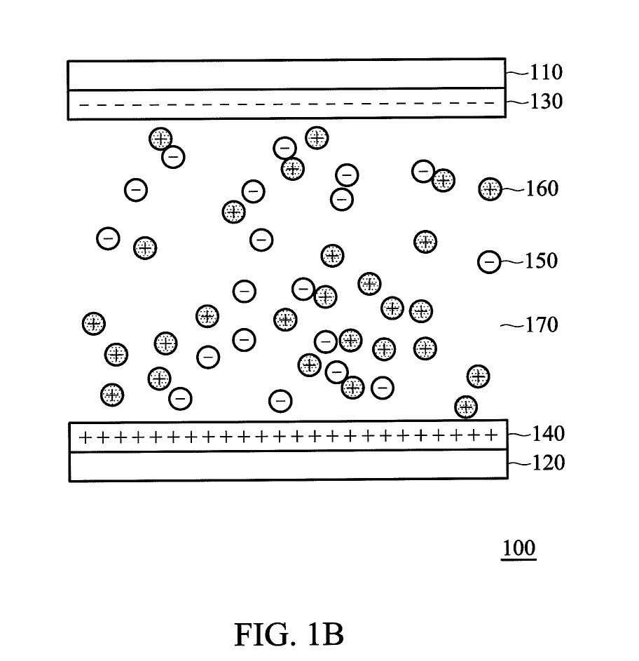

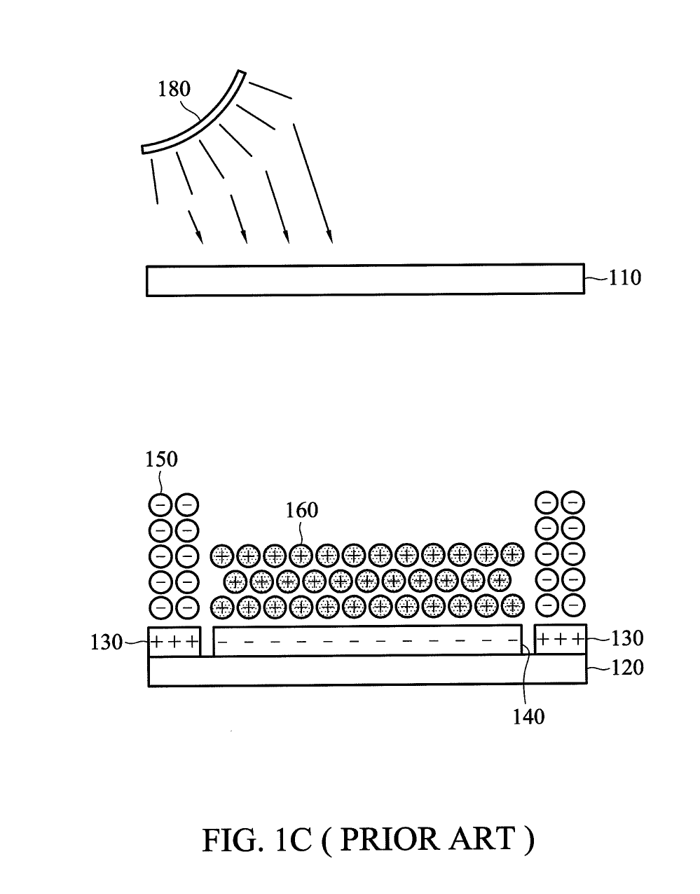

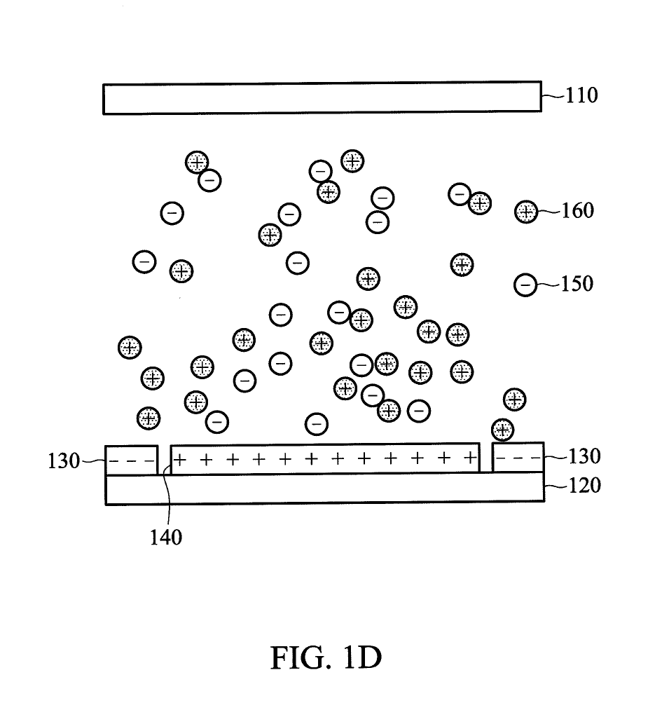

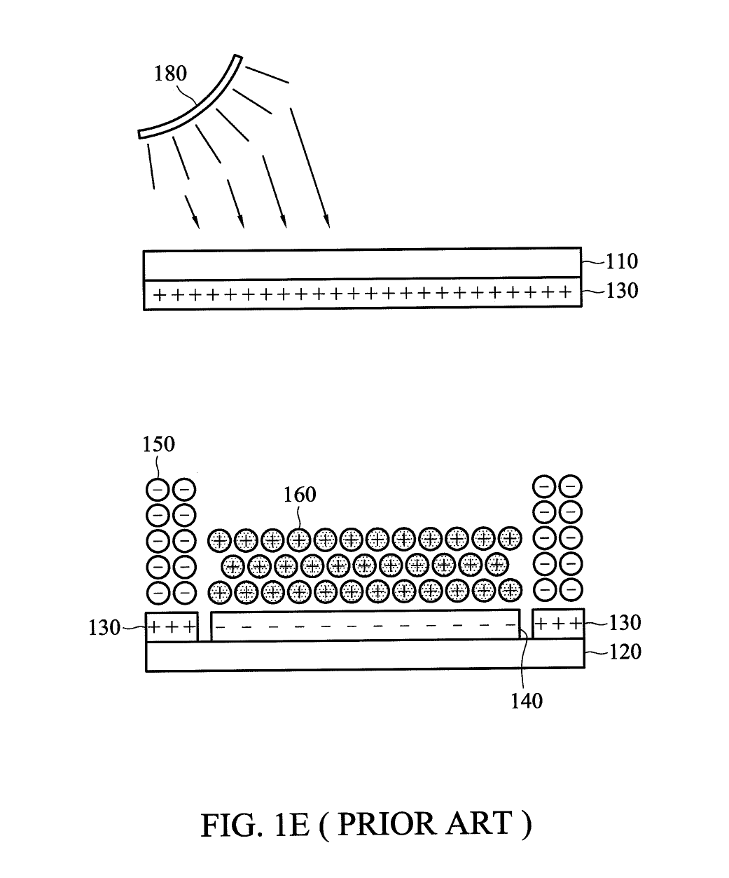

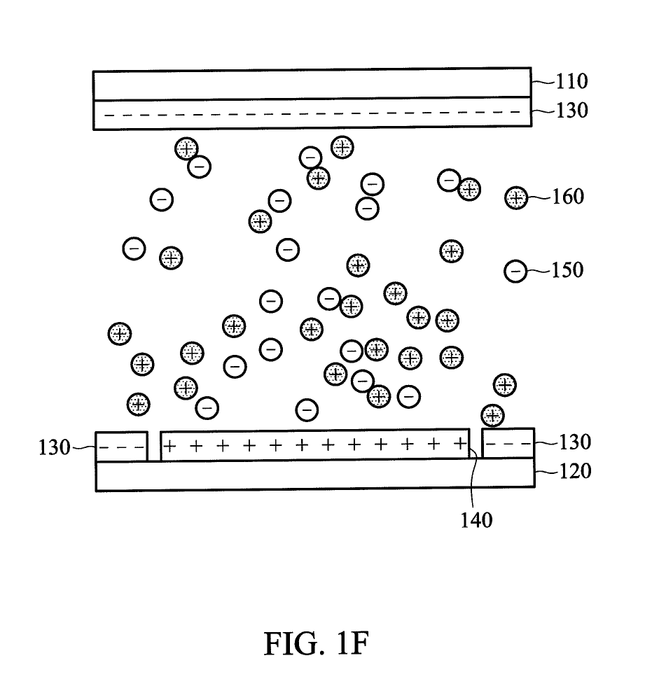

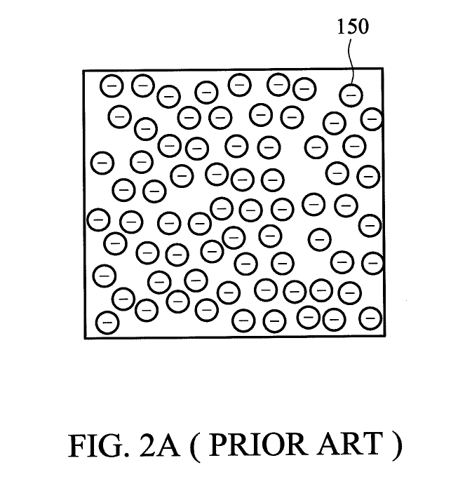

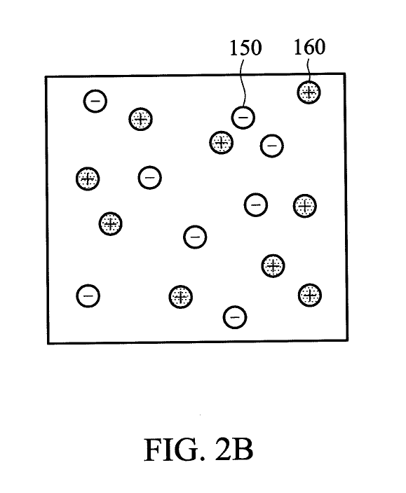

FIG. 1B is a side view of the top-down switching mode electrophoretic display device when it is under a non-imagewise bistable state of idling according to the present invention. FIG. 2B is a top view of the electrophoretic display device when it is under a non-imagewise bistable state of idling according to the present invention. Referring to both FIGS. 1B and 2B, when the electrophoretic display device 100 is under a non-imagewise bistable state of idling, only very few image particles 150 and 160 contact the electrodes 130 and 140, respectively. As such, most particles will not touch the electrode 130 or 140, thus hindering high leakage current. As stated before, high leakage current reduces charges on the image particles and leads to image sticking. According to the present invention, there is a non-imagewise bistable state of idling for the electrophoretic display device, which can minimize image sticking. According to the present invention, the non-imagewise bistable state of idling can help maintain charges on particles which can replace the frame refreshing technology of prior art. As a result, the non-imagewise bistable state of idling will hinder sticky images from occurring and extend operating life span for electrophoretic display devices.

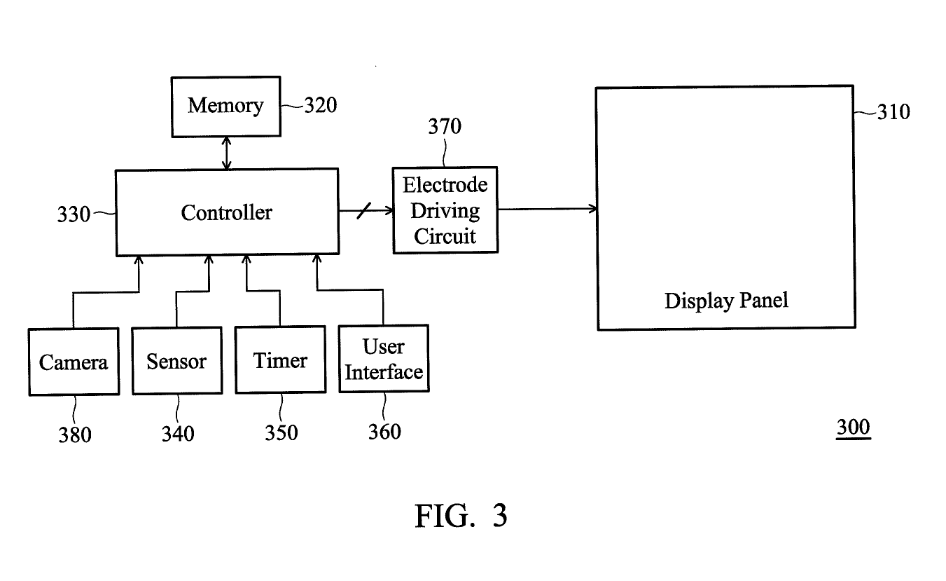

FIG. 3 shows a schematic view for the structure of the electrophoretic displays according to the present invention. As shown in FIG. 3, the electrophoretic display device 300 comprises a display panel 310, a system controller 330, a driving circuit 370, and a sensor or detector 340. The system controller 330 can control the display panel 310 for either a display or idle mode via the driving circuit 370, based on the input from the sensor or detector 340. According to a preferred embodiment of the present invention, the sensor or detector 340 can detect or sense the state of the electrophoretic display device 300, or the parameters associated with the surrounding environment of the electrophoretic display device 300. As an example, the state or the parameters include, but are not limited to, light intensity, temperature, operating voltage, motion, acceleration, and inactive time period. In accordance with a preferred embodiment of the present invention, the electrophoretic display device 300 includes a memory element 320, which is electrically connected to the system controller 330, for storing the last image for the display panel 310 before it has entered into a non-imagewise bistable state of idling.

According to a preferred embodiment of the present invention, the electrophoretic display 300 further includes a user interface 360, which is electrically coupled to the system controller 330. The system controller 330 controls the driver circuit 370, based on the operation status of the user interface 360, to define either the display or idle driving mode of the display panel 310. According to another preferred embodiment of the present invention, the electrophoretic display 300 further includes a timer 350, which is electrically connected to the system controller 330. Similarly, the system controller 330 controls the driving circuit 370, based on the time transpired according to the timer 350, to define either the display or idle driving mode of the display panel 310. In accordance with a preferred embodiment of the present invention, the electrophoretic display 300 also includes a camera 380, which is electrically coupled to the system controller 330, plus a face recognition program to control the driver circuit 370, to define either the display or idle driving mode of the display panel 310. The combination of the camera 380 and the face recognition program can effectively prevent the electrophoretic display device 300 from entering a non-imagewise bistable state of idling by error.

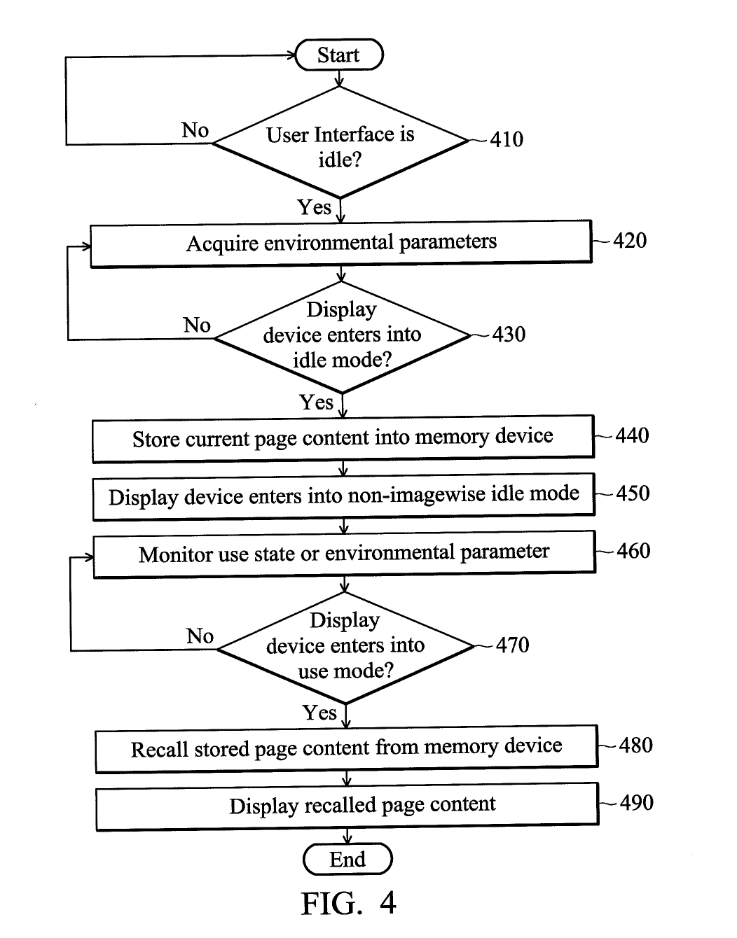

FIG. 4 shows the flow chart for the driving method of the electrophoretic display device according to the present invention. With reference to both FIGS. 3 and 4, when there is no input to the User Interface 360, the electrophoretic display device 300 is in a static display mode (step 410; for example, the user interface 360 is inactivated). The system controller 330 acquires all of the environmental parameters via one or more sensors or detectors 340 (step 420). When the system controller determines that the display panel 310 has entered into an idle mode (step 430), the current page content will be stored into the memory device 320 (step 440). The display panel 310 is then driven to the non-imagewise idle mode, where no image is perceivable, from the display mode (step 450), thus minimizing image sticking and expanding operating life span of a display device by maintaining proper electric charges for particles, and by minimizing the clustering of particles.

When the display panel 310 is under a non-imagewise bistable state of idling, the sensor or detector 340 will continue to monitor the state of use or environmental parameters of the electrophoretic display device 300 (step 460). When the display panel 310 is in the idle mode, all sensors continue to send signals to the system controller 330. Once the system controller 330 determines that the display panel 310 should be switched back to a use mode (step 470), the system controller 330 will recall content of a last page from the memory device 320 (step 480). Finally the display panel 310 displays the same content as the last page (step 490), which was stored before the display panel 310 was in the bistable non-imagewise idle mode.

In accordance with a preferred embodiment of the present invention, the electrophoretic display device 300 includes a user interface 360 and a timer 350, such as DS12885 of Maxim Integrated Products, Inc. An operator, through the user interface 360, can set timer 350 limits for the time required to elapse before the display panel 310 enters into the bistable non-imagewise idle mode. When there is no activation at the user interface 360, the timer 350 starts to count time until it reaches a set limit. Then the system controller 330 determines that there is no one viewing the display panel 310 and sends an idle command to the driving circuit 370 so as to switch the display panel 310 into a non-imagewise bistable state of idling. Thereafter, if there is activation at the user interface 360, the system controller 330 will wake up the electrophoretic display device 300 to switch out of the non-imagewise bistable state of idling and back in normal use.

According to a preferred embodiment of the present invention, the electrophoretic display device 300 includes a light sensor 340 (such as APDS-9002 from AVAGO) and a timer 350. When the user interface 360 is not activated, the system controller 330 turns on the light sensor 340 to measure the background lighting near the display panel 310. If the lighting level is below a limit, the timer 350 will be activated by the system controller 330. Once the preset timer limit is reached and the user interface 360 is not activated, the system controller 330 determines that the display panel 310 will enter a non-imagewise bistable state of idling when a lighting level remains below a preset level. When the display panel 310 is in a non-imagewise bistable state of idling, the light sensor 340 will continue to measure a lighting level and send the result to the system controller 330. When the lighting level is high enough or the user interface 360 is activated, the electrophoretic display device 300 will switch out of the non-imagewise bistable state of idling.

According to a preferred embodiment of the present invention, the electrophoretic display device 300 includes an accelerometer sensor 340 (such as ADXL345 from Analog Device) and a timer 350. When the user interface 360 is not activated, the accelerometer sensor 340 will be turned on by the system controller 330. If, within the time limit set by the timer 350, the input from the accelerometer sensor 340 remains steady while the user interface is not activated, then the system controller 330 determines that there is no viewer and instructs the driving circuit 370 to have the display panel 310 enter into a non-imagewise bistable state of idling. The advantage of this embodiment is that the electrophoretic display device 300 can still enter into an idle mode when the display panel 310 is not being viewed, even when background lighting is high. Afterwards, if the accelerometer sensor 340 senses movement, or the user interface 360 is activated, then the system controller 330 determines that the electrophoretic display device 300 should switch out of the non-imagewise bistable state of idling.

It is noted that the sensor or detector 340 is capable of measuring changes in signal output corresponding to certain specific characteristics. Such changes can be used as a reference to determine changes of states or conditions. There are environmental sensors and change-of-condition sensors. Environment sensors can measure various physical phenomena of the environment, and they fall into several categories such as heat sensors, light sensors, voice sensors, electrical signal sensors, mechanical force sensors, etc. The change-of-condition sensors refer to system condition changes as being detected by the system controller 330, including commands, time span, and frequencies. In addition, the sensor or detector 340 can be based on a device with fixed functions, a sensor or detector with certain defined functions, or an integration of several different types of sensors or detectors.

In accordance with a preferred embodiment of the present invention, the electrophoretic display device 300 includes a camera 380, and the system controller 330 includes human face detection software. The combination of the camera 380 and the human face detection software can effectively prevent a false idle state for the electrophoretic display device 300. For example, as mentioned above, when the user interface 360 is not activated, the system controller 330 can turn on the light sensor 340 to measure the background lighting near the display panel 310. If the lighting level is below a set limit, the system controller 330 may turn on a camera 380 to capture one or more pictures and transmit them to the system controller 330 with human face detection enabled. If the system controller 330 can successfully detect a human face, which means someone is viewing the display panel 310, then the system controller 330 would determine that there is a sensor signal error and thus will maintain pictures of the display device. Similarly, the system controller 330 will turn on the accelerometer sensor 340 if the user interface 360 is not activated. This is to prevent the electrophoretic display device 300 from mistakenly switching the display panel 310 to a non-imagewise bistable state of idling due to slow viewing speed. The system controller 330 can also turn on a camera 380 with human face detection software. If a human face is successfully detected, then the system controller 330 will continue to show the pictures. It is noted that the camera 380 and the system controller software can be integrated with various types of sensors in the electrophoretic display devices 300 so that errors in detection due to false sensor signals can be effectively avoided.

According to a preferred embodiment of the present invention, before the panel display 310 has entered into a non-imagewise bistable state of idling, it stores a content of a current page into the memory device 320. The advantage of doing this is to have the last page redisplayed after the display panel 310 is recovered from a non-imagewise bistable state of idling. This will minimize any inconveniences due to the switching of the non-imagewise bistable state of idling. As another example, the electrophoretic display device 300 includes a memory device 320, and the display panel 310 can display both static and dynamic pictures simultaneously. When the system controller 330 determines that the display panel 310 will enter into a non-imagewise bistable state of idling, the current content on static display device will be stored into the memory device 320 while the file name, path and length/time played will be recorded in the memory device 320 as well. When panel use is resumed, the memory device 320 will be requested by the system controller 330 to display the static last page or the dynamic image anew.

There are various kinds of memory devices 320 which may be included in the electrophoretic display device 300 so that it can serve the purpose of storing the last page. For example, the electrophoretic display device 300 includes a light sensor 340, a timer 350, and a memory device 320 which can be DRAM (EDS2516AFTA from ELPIDA), or FLASH (NOR FLASH K8P2915UQB from Samsung) with batteries for independent use. As mentioned above, under insufficient background lighting but sufficient battery voltage, the system controller 330 will determine that the display panel 310 should enter into a non-imagewise bistable state of idling while content of a last page is first stored into the memory device 320. When the background lighting is sufficient, the system controller 330 will determine that the display panel 310 should switch back to a normal use mode. Content of a last page stored in memory device is accessed by the system controller 330 to replace the screen for the non-imagewise bistable state of idling.

As another example, when the electrophoretic display device 300 is in use while the battery voltage is running low, the electrophoretic display device 300 will start to turn off after storing the content into FLASH or a similar device so as to prevent data loss and drive the display panel 310 to a non-imagewise bistable state of idling. If the electrophoretic display device 300 is powered up again, the system controller 330 will move the content stored in the FLASH or a similar device to replace the non-imagewise bistable state of idling look of the display panel 310. It is noted that the memory device 320 may all be temporary or permanent data storage devices or combinations thereof, including, but not limited to, an SRAM, DRAM, FLASH, MRAM, PRAM, Hard disc, and SSD, etc.

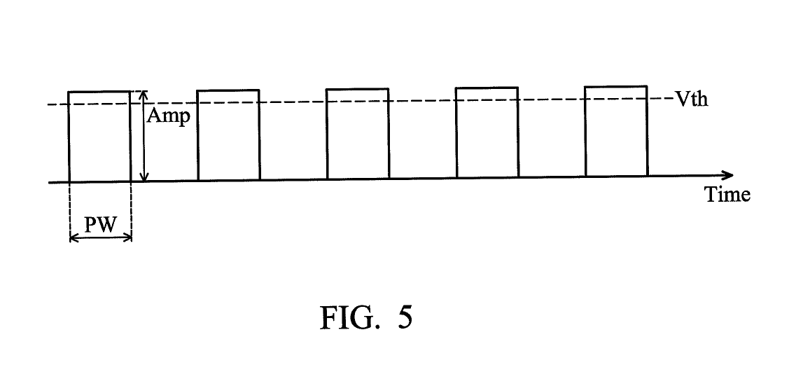

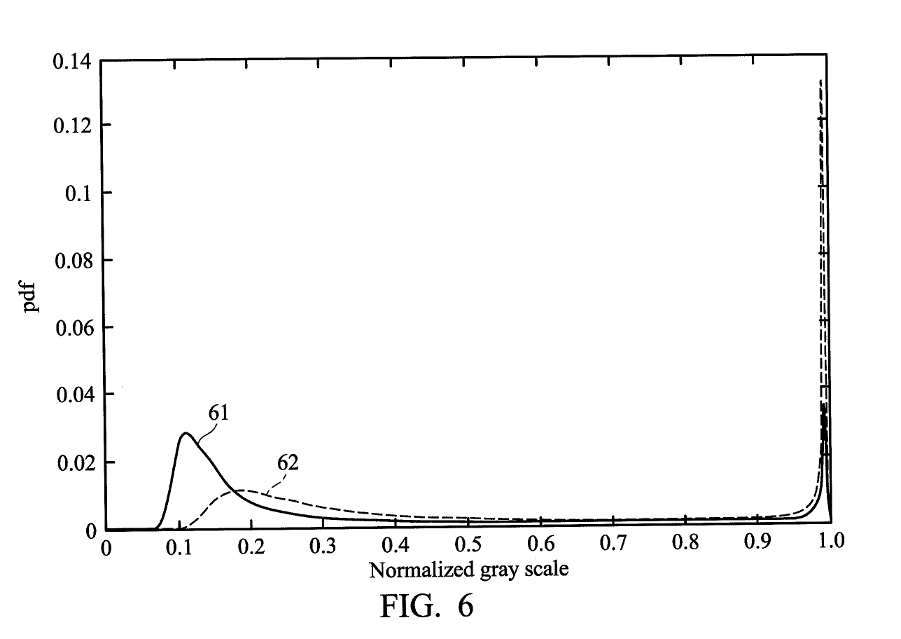

As shown in FIGS. 1B and 3, the electrode driving circuit 370 applies an electric field between the first electrode 130 and the second electrode 140 to induce a near threshold voltage. The resultant Coulomb forces drive the pigment particles 150 and 160 gradually away from the surfaces of the electrodes and leave the pigment particles 150 and 160 in the area 170. The electrode driving circuit 370 can utilize pulse width modulation (PWM), frequency modulation (FM), or amplitude modulation (AM), or any combinations to achieve the driving scheme. One example is shown in the experiment of FIG. 5. The electrode driving circuit 370 applies a combination of AM and PWM to drive the display panel 310 to a non-imagewise bistable state of idling. The multiple-point mapping plot of the display panel 310 under a black mode and a non-imagewise bistable state of idling is plotted with an upward lighting under microscope. The pixel area distribution of brightness reading is converted into a plot of normalized grey scale distribution as shown in FIG. 6. Curves 61 and 62 represent plots of a normalized grey scale distribution for a black mode picture and picture for a non-imagewise bistable state of idling, respectively, where the normalized grey scale 0 indicates a black image while 1 indicates a white image. The normalized gray scale has a high peak near the gray scale 1 on curve 62, which means the display cell 100 is observed as a pixel with high gray scale. In other words, the light from the lower light source of the microscope passes through the display cell 100 because the pigment particles 150 and 160 disperse in the area 170 instead of staying on the electrode. In comparison, the beam from the lower light source can not pass through the display cell 100 since the pigment particles 150 and 160 stay on the electrode. Therefore, a small peak appears on the lower side of the normalized gray scale. Comparing curves 61 and 62, it is apparent that pigment particles do not stay on the electrode surfaces 130 and 140 but spread out in the area 170.

Therefore, the electrode driving circuit 170 can be fine tuned with respect to a combination of the various modulation methods like PWM, FM and AM to optimize the non-imagewise bistable state of idling with minimal pigment particles on the electrode surfaces 130 and 140. This will minimize the charge loss of the pigment particles.

As described in the co-pending application No. 61/335,935, filed Jan. 12, 2010, which is hereby incorporated by reference in its entirety, at least one of the first and second electrodes is preferably coated with a semiconducting passivation layer such that the statically charged pigment particles attracted to the substrates in response to a voltage between the first substrate and the second substrate will be in contact with the semiconducting passivation layer, instead of the electrode surfaces.

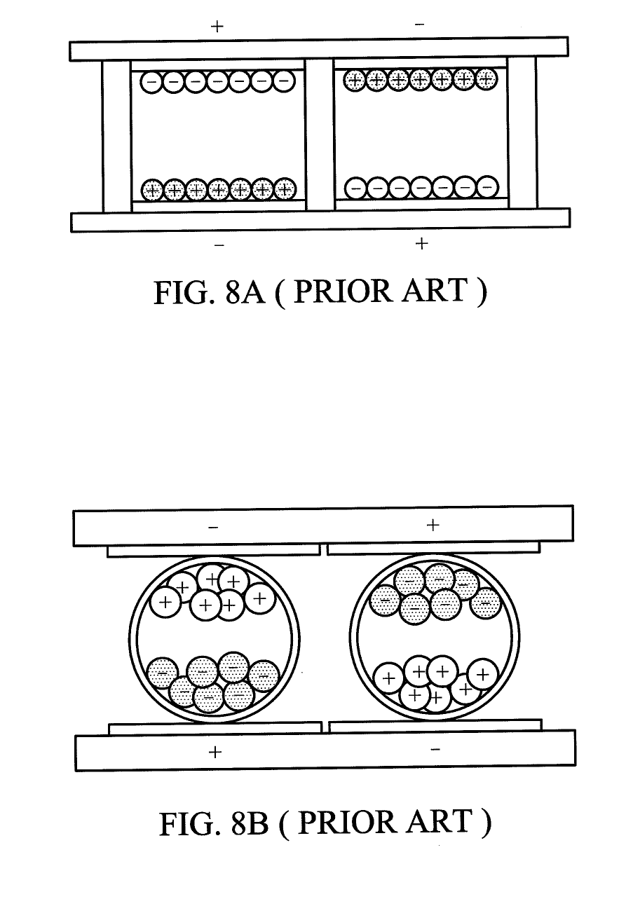

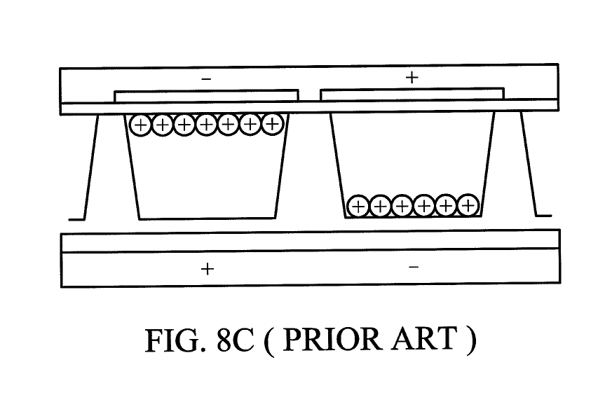

In addition, the method for driving the electrophoretic display device according to the present invention can also be applied to the powder type electrophoretic display device (e.g., FIG. 8A), the microcapsule type electrophoretic display device (e.g., FIG. 8B), and the microcup type electrophoretic display device (e.g., FIG. 8C).

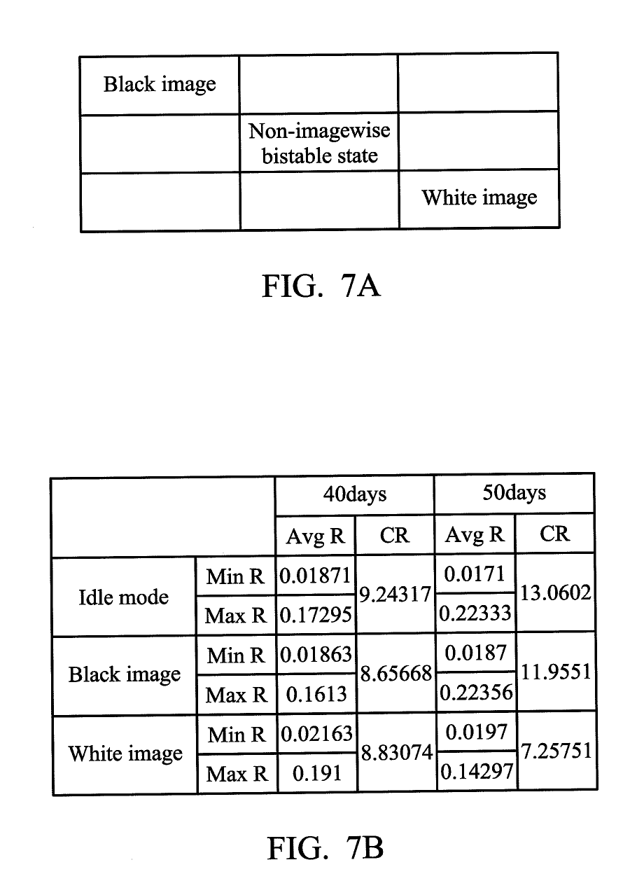

As an illustration of one embodiment of the present invention, an experiment was conducted to show the non-imagewise bistable mode performance of the electrophoretic display device 300. A Quick Response Liquid Powder Display (QR-LPD) manufactured by Bridgestone was used as an example. As shown in FIG. 7A, three areas of QR-LPD were driven to black image, non-imagewise bistable state of idling and white image, respectively. They were kept in an accelerated test condition at 40 C and 95% RH for a long period of time while monitoring their contrast ratio, threshold voltage, and response time. As shown in FIG. 7B, the three areas of QR-LPD present different contrast ratio after acceleration aging test. Although experiment results vary with aging of QR-LPD, the contrast ratio for the non-imagewise bistable idle mode is still higher than that of the black or white image over by 10%. The difference got bigger and was proportional to the accelerated test time. The experiment results show that decay of contrast ratio can be minimized by keeping the display panel in a non-imagewise bistable idle mode.

In summary, the first aspect of the present invention is directed to an electrophoretic display device having an essential non-imagewise bistable state, which comprises a first substrate, a second substrate, a plurality of charged particles disposed between the first and second substrates, a driving circuit, and a sensor. The second substrate is opposite to the first substrate. The plurality of charged particles is disposed between the first and second substrates. The driving circuit is configured for a display mode by imagewise driving the plurality of charged particles to display one or more images and configured for an idle mode by causing the plurality of charged particles to move away from at least one of the two substrates and to be non-imagewise dispersed in between the two substrates so as to form a substantially non-imagewise bistable state between the two substrates in the idle mode. The sensor senses or detects a usage status of the electrophoretic display device or one or more environmental parameters associated with a surrounding environment of the electrophoretic display device, wherein the driving circuit is configured for either the display mode or the idle mode in accordance with the usage status or the one or more environmental parameters sensed or detected.

The second aspect of the present invention is directed to a method for driving an electrophoretic display device which comprises a first substrate, a second substrate opposite to the first substrate, a first electrode disposed on the first substrate, a second electrode disposed on the second substrate, a plurality of charged particles disposed in between the first and second substrates, and a sensor. The method comprises sensing or detecting a usage status of the electrophoretic display device or one or more environmental parameters associated with a surrounding environment of the electrophoretic display device; and in accordance with the usage status or the one or more environmental parameters sensed or detected, generating either an electric field to cause the plurality of charged particles to move imagewise toward and to contact with at least one of the first and second electrodes or another electric field to cause the plurality of charged particles to move non-imagewise and substantially away from the first and second electrodes so as to form a substantially non-imagewise bistable state.

The third aspect of the present invention is directed to a method for driving an electrophoretic display device which comprises a first substrate, a second substrate opposite to the first substrate, a first electrode disposed on the second substrate, a second electrode disposed on the second substrate, a plurality of charged particles disposed in between the first and second substrates, and a sensor. The method comprises sensing or detecting a usage status of the electrophoretic display device or one or more environmental parameters associated with a surrounding environment of the electrophoretic display device; and in accordance with the usage status or the one or more environmental parameters sensed or detected, generating either an electric field to cause the plurality of charged particles to move imagewise toward and to contact with at least one of the first and second electrodes or another electric field to cause the plurality of charged particles to move non-imagewise and substantially away from the first and second electrodes so as to form a substantially non-imagewise bistable state.

An electrophoretic display apparatus or device and a driving method for the display are provided. An embodiment of a display device comprises a first substrate, a second substrate, and a plurality of pigment or dye particles disposed between the first and second substrates. More specifically, this invention provides an improved method to significantly reduce image sticking and extend display device life span by using a sensing or detecting mechanism to sense or detect a state (motion/still) or surrounding environment (dark/bright or sound or voice/background noise) of the display device, and a memory mechanism or device to memorize the last page image before the display is switched to the idle mode. Specifically, when the sensor or detector detects that the display is in the idle state of an environment where no user is watching or is capable of viewing the display image, the driver will activate a special driving mode to pull some or most of the pigment particles away from the electrodes to form a low contrast image or a imageless frame of low color density. In the meantime, the memory mechanism or device will memorize the last page image just before the display is driven to the idle mode. The last page image will be resumed immediately after the sensor or detector detects that the display is in the In-use state of environment. Since the number of pigment particles directly contacting the electrode is significantly reduced in the idle mode, image sticking is dramatically reduced and the operating life span of the display device is significantly increased. Moreover, since the last page image is resumed immediately after the display is switched back to the normal driving mode, in most cases, if not in all cases, a viewer will not notice any change in the image.

In sum, an electrophoretic display apparatus or device and a driving method for the display are provided. An embodiment of the display device comprises a first substrate, a second substrate, and a plurality of pigment or dye particles disposed between the first and second substrates. More specifically, the present invention directs to an improved method to significantly reduce the image sticking and extend the display life time by using a sensing or detecting mechanism for the state (motion/still) or environment (dark/bright or sound or voice/background noise) of the display device, an idle mode of the display image, and a memory mechanism or device to memorize the last page image before the display is switched to the Idle mode. Even more specifically, when the sensor or detector detects that the display is in the Idle state of the environment in which no one is watching or is capable of watching the display image, a driver will activate a special driving mode to pull some or most of the pigment particles away from the electrodes to form a low contrast image or a imageless frame of low color density. In the mean time, the memory mechanism or device will memorize the last page image just before the display is driven into the idle mode. The last page image will be resumed immediately after the sensor or detector detects that the display is in the In-use state of environment. Since the number of pigment particles directly contacting the electrode is significantly reduced in the idle mode, the image sticking is dramatically reduced and the life time of the display device is significantly improved. Moreover, since the last page image is resumed immediately after the display is switched back to the normal driving mode, in most cases if not in all cases, a viewer will not notice any change of the image.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrophoretic display device, comprising:
a first substrate;
a second substrate opposite to the first substrate;
a plurality of charged particles disposed between the first and second substrates;
a driving circuit configured for a display mode by imagewise driving the plurality of charged particles to display one or more images and configured for an idle mode by causing the plurality of charged particles to move away from at least one of the two substrates and to be non-imagewise dispersed in between the two substrates so as to form a substantially non-imagewise bistable state between the two substrates in the idle mode; and
a sensor for sensing or detecting a usage status of the electrophoretic display device or one or more environmental parameters associated with a surrounding environment of the electrophoretic display device, wherein the driving circuit is configured for either the display mode or the idle mode in accordance with the usage status or the one or more environmental parameters sensed or detected.

2. The electrophoretic display device of claim 1, wherein the plurality of charged particles are suspended in a gaseous medium.

3. The electrophoretic display device of claim 1, wherein the plurality of charged particles have different polarities and contrast colors.

4. The electrophoretic display device of claim 1, wherein the plurality of charged particles are dispersed in a dielectric medium.

5. The electrophoretic display device of claim 1, further comprising a first electrode formed on the first substrate, and a second electrode formed on the second substrate, wherein the driving circuit is electrically coupled to the first and second electrodes.

6. The electrophoretic display device of claim 1, further comprising a first and second electrode both formed on the same substrate, wherein the driving circuit is electrically coupled to the first and second electrodes.

7. The electrophoretic display device of claim 1, further comprising a first electrode formed on the first substrate, and a second and third electrode both formed on the second substrate, wherein the driving circuit is electrically coupled to the first, second and third electrodes.

8. The electrophoretic display device of claim 1, wherein the driving circuit is configured to operate in at least one of pulse width modulation, frequency modulation, voltage modulation, and amplitude modulation.

9. The electrophoretic display device of claim 1, further comprising a system controller, electrically coupled to the driving circuit, for controlling the driving circuit for either the display mode or the idle mode.

10. The electrophoretic display device of claim 1, wherein the sensor is selected from the group consisting of a motion sensor, an acoustic sensor, a thermal sensor, a light sensor, an accelerometer, an electrical signal sensor, a mechanical sensor, a command receiver, and a frequency detector.

11. The electrophoretic display device of claim 9, further comprising a memory electrically coupled to the system controller, wherein the driving circuit is configured for the idle mode and the memory is configured to store the last image data prior to switching to the idle mode.

12. The electrophoretic display device of claim 11, wherein the driving circuit is configured for the display mode upon sensing the usage status of the electrophoretic display device or the one or more environmental parameters in the idle mode by the sensor in accordance with the last image data stored in the memory before the driving circuit is configured for the idle mode.

13. The electrophoretic display device of claim 9, further comprising a user interface electrically coupled to the system controller, wherein the system controller is configured to control the driving circuit for the display mode when the user interface is activated, and wherein the system controller is configured to control the driving circuit for the idle mode when the user interface is inactivated.

14. The electrophoretic display device of claim 9, further comprising a timer electrically coupled to the system controller, wherein the system controller is configured to control the driving circuit for either the display mode or the idle mode in accordance with a predetermined time period counted by the timer.

15. The electrophoretic display device of claim 9, further comprising a camera electrically coupled to the system controller, wherein the system controller is configured to control the camera to capture a human face, the system controller comprises human face detection software for recognizing the human face, and the system controller is further configured to control the driving circuit for either the display mode or the idle mode in accordance with a recognition result from the human face detection software.

16. The electrophoretic display device of claim 9, further comprising:
a user interface electrically coupled to the system controller, wherein the system controller is configured to control the driving circuit for the display mode when the user interface is activated, and wherein the system controller is further configured to control the driving circuit for the idle mode when the user interface is inactivated; and
a timer electrically coupled to the system controller, wherein the timer is configured to start counting when the user interface is inactivated, the system controller is configured to control the driving circuit for the idle mode subsequent to a predetermined time period counted by the timer, and the system controller is configured to control the driving circuit for the display mode subsequent to activation of the user interface.

17. The electrophoretic display device of claim 9, wherein the sensor is electronically coupled to the system controller.

18. The electrophoretic display device of claim 5, wherein at least one of the first and second electrodes is coated with a semiconducting passivation layer.

19. The electrophoretic display device of claim 6, wherein at least one of the first and second electrodes is coated with a semiconducting passivation layer.

20. The electrophoretic display device of claim 7, wherein at least one of the first, second and third electrodes is coated with a semiconducting passivation layer.

21. A method for driving an electrophoretic display device, wherein the electrophoretic display device comprises a first substrate, a second substrate opposite to the first substrate, a first electrode disposed on the first substrate, a second electrode disposed on the second substrate, a plurality of charged particles disposed in between the first and second substrates, and a sensor, comprising:
sensing or detecting a usage status of the electrophoretic display device or one or more environmental parameters associated with a surrounding environment of the electrophoretic display device; and
in accordance with the usage status or the one or more environmental parameters sensed or detected, generating either an electric field to cause the plurality of charged particles to move imagewise toward and to contact with at least one of the first and second electrodes or another electric field to cause the plurality of charged particles to move non-imagewise and substantially away from the first and second electrodes so as to form a substantially non-imagewise bistable state.

22. The method of claim 21, wherein the usage status and the one or more environmental parameters sensed or detected comprise at least one of light intensity and temperature of a surrounding environment of the electrophoretic display device, and an operating voltage, motion, acceleration and an inactive time period associated with the electrophoretic display device.

23. The method of claim 21, wherein generating another electric field comprises applying a voltage approximate to the threshold voltage of the plurality of charged particles.

24. The method of claim 21, further comprising driving the plurality of charged particles to move imagewise toward and to contact with the first and second electrodes in response to activation of a user interface.

25. The method of claim 21, wherein generating another electric field between the first and second electrodes comprises counting to a predetermined time limit.

26. The method of claim 21, further comprising storing last image data of the electrophoretic display device prior to generating the another electric field between the first and second electrodes.

27. The method of claim 26, further comprising:
upon sensing or detecting the usage status of the electrophoretic display device or the one or more environmental parameters in the idle mode by the sensor, displaying an image corresponding to the last image data stored before the electrophoretic display device was switched to the idle mode.

28. The method of claim 21, wherein sensing the usage status or the one or more environmental parameters comprises capturing a picture and recognizing the picture.

29. The method of claim 28, further comprising driving the plurality of charged particles to move imagewise toward and to contact with the first and second electrodes when a human face is recognized in the picture.

30. The method of claim 21, wherein generating another electric field comprises performing at least one of pulse width modulation, frequency modulation, voltage modulation, and amplitude modulation.

31. The method of claim 21, wherein the environmental parameters comprises sound, temperature, light intensity, motion, acceleration, an electrical signal, and mechanical force.

32. The method of claim 21, wherein the usage status comprises an instruction of control, time of use, and frequency of use.

33. The method of claim 21, wherein the plurality of charged particles are suspended in a gaseous medium.

34. The method of claim 21, wherein the plurality of charged particles have different polarities and contrast colors.

35. The method of claim 21, wherein the plurality of charged particles are dispersed in a dielectric medium.

36. The method of claim 21, wherein the electrophoretic display device further comprises a third electrode disposed on the second substrate.

37. A method for driving an electrophoretic display device, wherein the electrophoretic display device comprises a first substrate, a second substrate opposite to the first substrate, a first electrode disposed on the second substrate, a second electrode disposed on the second substrate, a plurality of charged particles disposed in between the first and second substrates, and a sensor, comprising:
sensing or detecting a usage status of the electrophoretic display device or one or more environmental parameters associated with a surrounding environment of the electrophoretic display device; and
in accordance with the usage status or the one or more environmental parameters sensed or detected, generating either an electric field to cause the plurality of charged particles to move imagewise toward and to contact with at least one of the first and second electrodes or another electric field to cause the plurality of charged particles to move non-imagewise and substantially away from the first and second electrodes so as to form a substantially non-imagewise bistable state.

38. The method of claim 37, wherein the usage status and the one or more environmental parameters sensed or detected comprise at least one of light intensity and temperature of a surrounding environment of the electrophoretic display device, and an operating voltage, motion, acceleration and an inactive time period associated with the electrophoretic display device.

39. The method of claim 37, wherein generating another electric field comprises applying a voltage approximate to the threshold voltage of the plurality of charged particles.

40. The method of claim 37, further comprising driving the plurality of charged particles to move imagewise toward and to contact with the first and second electrodes in response to activation of a user interface.

41. The method of claim 37, wherein generating another electric field between the first and second electrodes comprises counting to a predetermined time limit.

42. The method of claim 37, further comprising storing last image data of the electrophoretic display device prior to generating the another electric field between the first and second electrodes.

43. The method of claim 42, further comprising:
upon sensing or detecting the usage status of the electrophoretic display device or the one or more environmental parameters in the idle mode by the sensor, displaying an image corresponding to the last image data stored before the electrophoretic display device was switched to the idle mode.

44. The method of claim 37, wherein sensing the usage status or the one or more environmental parameters comprises capturing a picture and recognizing the picture.

45. The method of claim 44, further comprising driving the plurality of charged particles to move imagewise toward and to contact with the first and second electrodes when a human face is recognized in the picture.

46. The method of claim 37, wherein generating the another electric field comprises performing at least one of pulse width modulation, frequency modulation, voltage modulation, and amplitude modulation.

47. The method of claim 37, wherein the environmental parameters comprises sound, temperature, light intensity, motion, acceleration, an electrical signal, and mechanical force.

48. The method of claim 37, wherein the usage status comprises an instruction of control, time of use, and frequency of use.

49. The method of claim 37, wherein the plurality of charged particles are suspended in a gaseous medium.

50. The method of claim 37, wherein the plurality of charged particles have different polarities and contrast colors.

51. The method of claim 37, wherein the plurality of charged particles are dispersed in a dielectric medium.
